(19) United States
(12) Patent Application Publication
(10) Pub. No.: US 2012/0319859 A1
(43) Pub. Date: Dec. 20, 2012

(54) ORIENTATION DETECTOR FOR USE WITH A HAND-HELD SURGICAL OR DENTAL TOOL

(75) Inventors: Ilan Taub, Herzliya (IL); Mark Reifman, Rishon LeZion (IL)

(73) Assignee: CREATIVE TEAM INSTRUMENTS LTD., Rishon Lezion (IL)

(21) Appl. No.: 13/522,809

(22) PCT Filed: Jan. 20, 2011
(86) PCT No.: PCT/IL11/00071

§ 371 Date: Jul. 18, 2012

Related U.S. Application Data
(60) Provisional application No. 61/296,643, filed on Jan. 20, 2010.

(51) Int. Cl. G08B 21/00; G06F 15/00

(52) U.S. Cl. 340/689; 702/150

(57) ABSTRACT

Provided is a device for monitoring the orientation of a hand-held surgical or dental tool. The device includes one or more orientation sensors that generate signals indicative of an orientation of the device. A processor calculates from the signals a current orientation of the device, where the current orientation is specified by a unit vector defined by a first angle formed between the unit vector and a predetermined first fixed axis and a second angle formed by the unit vector and a second predetermined axis. The processor compares a current orientation of the device with a predetermined reference orientation of the device stored in the memory and provides an indication of the deviation between a current orientation of the device and the reference orientation.

### FIELD OF THE INVENTION

This invention relates to medical devices, and more specifically to hand-held surgical or dental tools.

### BACKGROUND OF THE INVENTION

The main goal of restorative dentistry is to attach a prosthetic device to the alveolar ridge as a substitute for lost teeth. In one method, cast crowns with attached reconstruction of the lost teeth are cemented to teeth flanking the missing teeth. In another method, implants are inserted into the alveolar ridge in the area of the lost teeth and then a reconstruction of the lost teeth is attached to the implants. In order for the prosthetic device to withstand the dislodging forces it encounters during mastication, the axes of the treated teeth or implants should be substantially parallel to each other. This requires drilling two or more bores into the jaw that are either parallel to each other or have a predetermined offset from each other.

Several systems are known to guide a dental handpiece to ensure that a bore being drilled is parallel to a previously drilled bore. Most of these systems rely on mechanical means that are inserted into the oral cavity and as such decrease the working space available to the dentist in the oral cavity, which makes working inside the oral cavity difficult.

U.S. Pat. No. 6,000,939 to Ray et al discloses attaching a drill orientation apparatus to a dental drill and attaching a tooth orientation apparatus to a tooth. Both orientation devices determine its orientation relative to a single fixed direction, such as the direction of the gravitational field, so that the orientation of the drill and the tooth are each specified by a single angle. The drill angular position signal and the tooth angular position signal are compared to each other and when the difference between the two angles is not within a predetermined range, an alarm may be sounded to alert the operator to adjust the orientation of the drill.

### SUMMARY OF THE INVENTION

The present invention provides a device for maintaining a hand-held surgical or dental tool in a desired orientation in space. The device of the invention comprises one or more orientation sensors configured to be attached to, or integral with, the hand-held tool. Readings from the orientation sensors are analyzed by a processor to continuously determine the current orientation of the device relative to a fixed reference orientation. In accordance with the invention, the current orientation and the reference orientation are specified by a unit vector defined by two angles formed between the unit vector and first and second predetermined axes. The deviation between the reference orientation and the current orientation of the device may be calculated and indicated to a user on a graphical display, preferably in a way which allows an intuitive correction of the orientation, and when the deviation exceeds a predetermined threshold, an alarm may be activated, in order to urge the user to manipulate the hand-held tool to bring the orientation of the device to the reference orientation.

In one embodiment of the invention, an orientation sensor is used comprising 3-axis angular rate gyroscope, in combination with a navigation computer. An initial reference orientation of the gyroscope is determined, and the deviation from the initial orientation of the device at any subsequent time is calculated by the navigation computer from the angular momentum history of the gyroscope. The navigation computer runs a mathematical algorithm which calculates current orientation based on the initial reference orientation and the angular momentum history. In another embodiment, the orientation sensors include a 3-axis accelerometer and a 3-axis compass that detect the directions of the Earth's gravitational and magnetic fields, respectively, which determine two fixed vectors in space. The two fixed vectors determine a geometrical plane whose normal specifies a unique orientation. In a third embodiment, the orientation sensor includes a stabilized gyroscope, installed on freely rotating frames. In this case, an initial orientation of the gyroscope is determined, and the orientation of the device at any subsequent time is determined from the relative positions of the three frames.

Thus, in its first aspect, the invention provides a device for monitoring the orientation of a hand-held surgical or dental tool comprising:

(a) one or more orientation sensors generating one or more signals indicative of an orientation of the device; and

(b) a processor with a memory configured to
(i) receive the signals from the orientation sensor;
(ii) periodically or continuously calculate from the received signals a current orientation of the device; the current orientation being specified by a current unit vector defined by a first current angle formed between the current unit vector and a predetermined first fixed axis and a second current angle formed by the current unit vector and a second predetermined axis.
(iii) compare a current orientation of the device with a predetermined reference orientation of the device stored in the memory; the referenced orientation being specified by a reference unit vector defined by a first angle formed between the reference unit vector and the predetermined first fixed axis and a second angle formed by the reference unit vector and the second predetermined axis.
(iv) provide an indication of a deviation between a current orientation of the device and the reference orientation.

In the device of the invention, the one or more orientation sensors may comprise, for example, a 3-axis rate gyroscope. Alternatively or additionally, the one or more orientation sensors comprise a 3-axis accelerometer and a 3-axis geomagnetic sensor. As yet another example, the one or more orientation sensors may comprise a gyroscope installed on freely rotating frames.

The device of the invention may further comprise means for affixing the device to the hand-held tool. The device of the invention may further comprise a graphical display for displaying an indication of a deviation between a current orientation of the device and the reference orientation. The graphical display may display an indication of Euler angles of the deviation between the reference orientation and a current orientation. The graphical display may display two Euler angles or three Euler angles.

The device of the invention may further comprises an alarm generating a sensible signal when the alarm is activated, in which case the processor would be further configured to activate the alarm when the deviation between the reference orientation and a current orientation exceeds a predetermined threshold. The processor may be further configured to receive data indicative of the reference orientation and to store the reference orientation in the memory.

The device may be provided with a set reference button that causes the processor to determine an orientation of the device when the set reference button is depressed and to store the determined orientation in the memory as the reference orientation.

In some embodiments, the device comprises a pilot that is adapted to be rigidly affixed to a body. The pilot comprises (a) one or more orientation sensors generating signals indicative of an orientation of the pilot, and (b) communication means configured to communicate the signals to the processor. In this case, the processor is further configured to receive the communicated signals and to determine a deviation between a current orientation of the device from the reference orientation in a method involving the transmitted signals.

In another of its aspects, the invention provides a surgical or dental tool comprising a device for monitoring the orientation of a hand-held surgical or dental tool, wherein the device comprises:

(a) orientation sensors generating one or more signals indicative of an orientation of the device; and

(b) a processor with memory configured to
(i) receive the signals from the orientation sensor;
(ii) periodically or continuously calculate from the received signals a current orientation of the device; the current orientation being specified by a current unit vector defined by a first current angle formed between the current unit vector and a predetermined first fixed axis and a second current angle formed by the current unit vector and a second predetermined axis.
(iii) compare a current orientation of the device with a predetermined reference orientation of the device stored in the memory; the referenced orientation being specified by a reference unit vector defined by a first angle formed between the reference unit vector and the predetermined first fixed axis and a second angle formed by the reference unit vector and the second predetermined axis.
(iv) provide an indication of a deviation between a current orientation of the device and the reference orientation.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1a shows an orientation detector for use with a hand held surgical or dental tool in accordance with one embodiment of the invention, and FIG. 1b shows the device of FIG. 1a attached to a dental drill;

FIG. 2 shows a schematic diagram of the electronics of the orientation detector of FIG. 1a;

FIG. 3 shows use of a dental drill to which the orientation dector of FIG. 1 has been attached prior to drilling an initial bore;

FIG. 4 shows the dental drill of FIG. 3 prior to drilling a second bore;

FIG. 5 shows the dental drill of FIG. 4 after correction of the orientation prior to drilling the second bore;

FIG. 6a shows a pilot adapted for insertion into a drilled bore, and FIG. 6b shows an orientation detector for use with a hand held surgical or dental tool in accordance with another embodiment of the invention that includes the pilot of FIG. 6a;

FIG. 7 shows an orientation detector in accordance with another embodiment of the invention;

FIG. 8 shows an orientation detector in accordance with a third embodiment of the invention; and

FIG. 9 shows a flow chart for orientating a hand-held surgical or dental tool in accordance with the aspect of the invention.

### DETAILED DESCRIPTION OF THE INVENTION

In the description below, the invention is exemplified with reference to dental drilling. This is by way of example only, and the invention may be used with any hand-held surgical or dental tool.

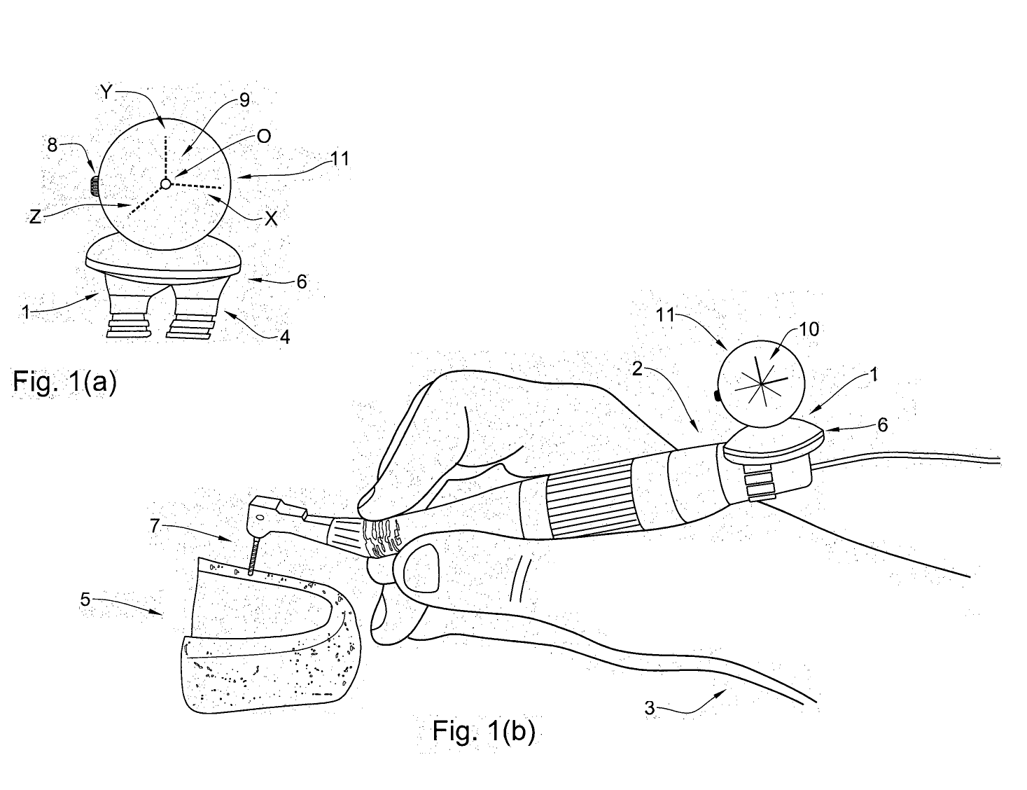

FIG. 1 a shows a device 1 for measuring and indicating the deviation of a hand-held surgical or dental tool from a predetermined orientation in space in accordance with one embodiment of the invention. The device 1 is shown in FIG. 1b firmly attached to a dental handpiece 2. This is by way of example only, and the device of the invention may be used with any surgical or dental tool whose orientation during use must be monitored. The handpiece 2 shown in FIG. 1b is grasped by a user's hand 3 while drilling with drill bit 7 into an alveolar ridge 5. The device 1 is attached to the handpiece 2 by means of a spring clamp 4, preferably at a location on the drill that does not enter the oral cavity during drilling. The device 1 comprises a base part 6 containing orientation sensors, as described below, and a main part 11 comprising electronic components, a set reference button 8, a buzzer, and a battery. The main part 11 also includes a graphic display 10 for graphically indicating the current orientation of the device relative to a fixed reference orientation.

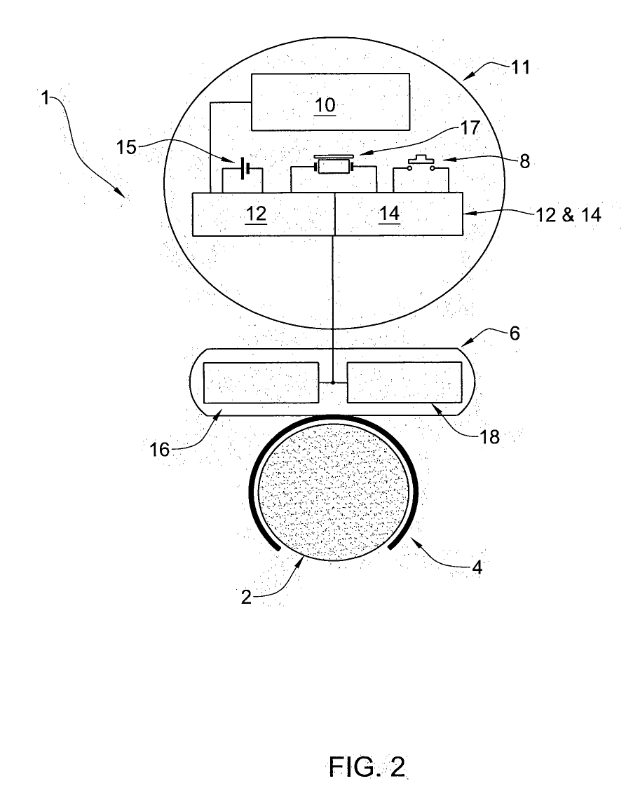

FIG. 2 shows schematically the electronics of the device 1 in accordance with one embodiment of the invention. The electronics include a microprocessor 12 having a memory 14. The microprocessor communicates with the set reference button 8, the graphical display 10, one or more orientation sensors 16 and 18, and an alarm 17. Power to the electronics is provided by a battery 15.

The one or more orientation sensors 16 and 18 generate one or more signals that are communicated to the processor. The one or more orientation sensors are selected so that the generated signals are indicative of an orientation of the device, where the orientation of the device is specified by means of a unit vector defined by an angle formed between the unit vector and each of a first and second predetermined direction. Thus for example, the device may include a 3-axis angular rate gyroscope. As another example, the device may include a 3-axis accelerometer and 3-axis compass. As yet another example, the device may include a stabilized gyroscope.

In use, the device 1 is affixed to a hand-held surgical or dental tool. The tool is then oriented in a desired reference orientation and the set reference button 8 is depressed. This causes this reference orientation of device 1 to be stored in the memory 14. Subsequently, the deviation of the orientation of device 1 from the reference orientation is indicated on the graphical display 10. When the deviation of the orientation of the device 1 from the reference orientation drill bit axis exceeds a predetermined threshold, the alarm 17 is activated to alert the user.

Referring again to FIG. 1, in one embodiment, the graphical display 10 indicates the deviation of the device orientation from the reference orientation by means of a 2-D display with a bar-graph X, parallel to the base 6, a bar-graph Y, perpendicular to the bar graph X, and a bar-graph Z. The X, Y and Z bar-graphs intersect in the center of the display, and the intersection is indicated by point O. The X, Y and Z bar-graphs continuously display the angular deviation by means of the Euler angles, indicating the corrections to be made in order to align the current orientation with the reference orientation.

Upon depressing the set reference button 8, the X, Y and Z bar-graphs are cleared and the O-point is turned-on to indicate the current orientation of the device is in the reference orientation. When the device orientation deviates from the reference orientation, the O-point is turned off and the lengths of the X, Y and Z bar-graphs are proportional to the two or three Euler angles indicating the extent of angular deviation from the reference orientation. When the measured deviation exceeds a predetermined threshold, the user is urged to correct the orientation of the device until all bar-graphs disappear and the O-point is turned on again. For the purpose of aligning two offset 3-dimensional vectors in space, the use of only two Euler angles, and thus only two bar graphs, may be sufficient. The use of three Euler angles, and thus three bar graphs, is preferable when a more precise alignment is required, for example, when drilling for asymmetrical bore fittings.

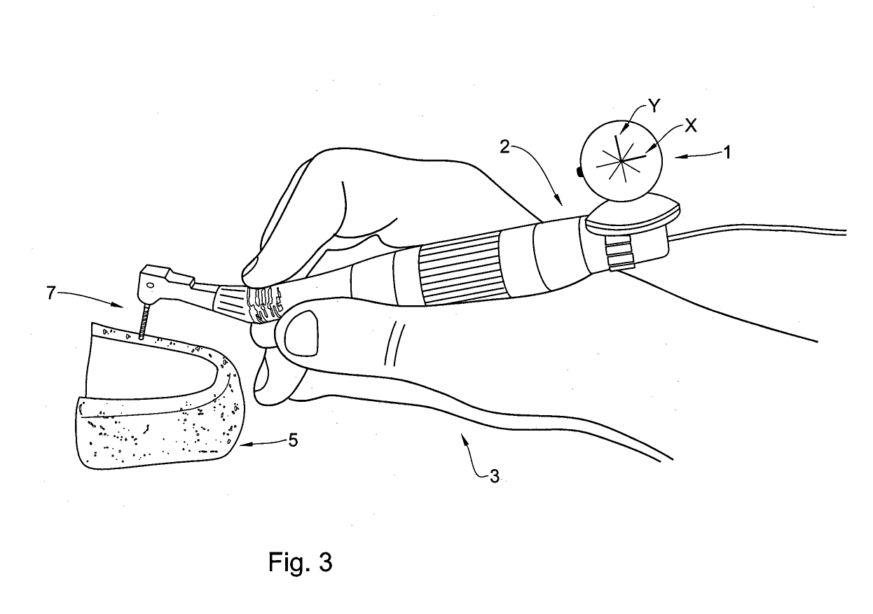

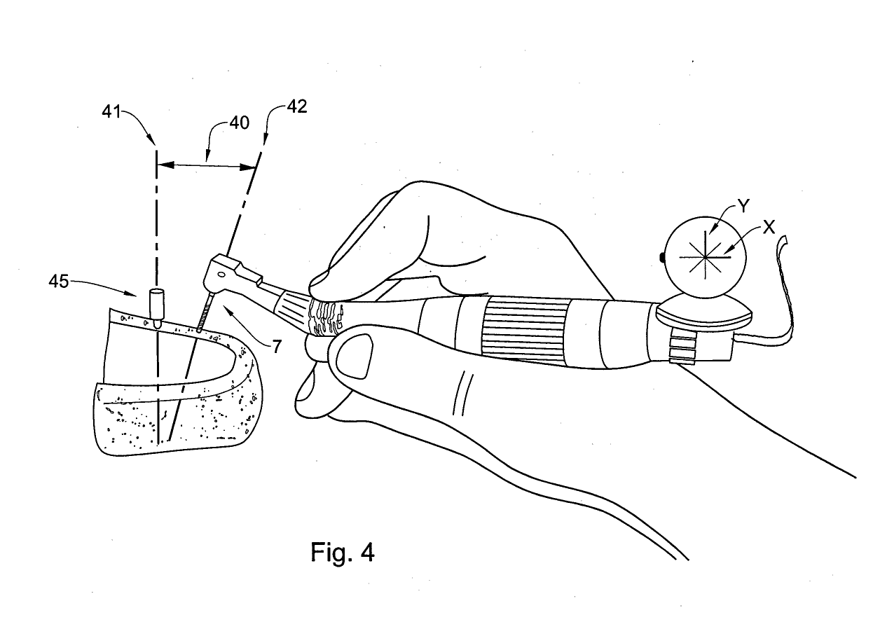

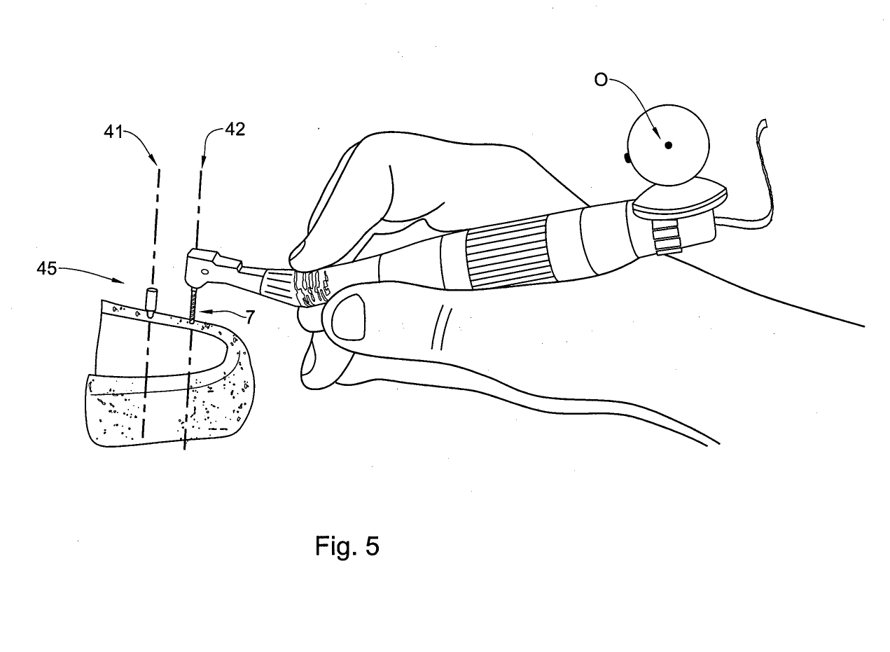

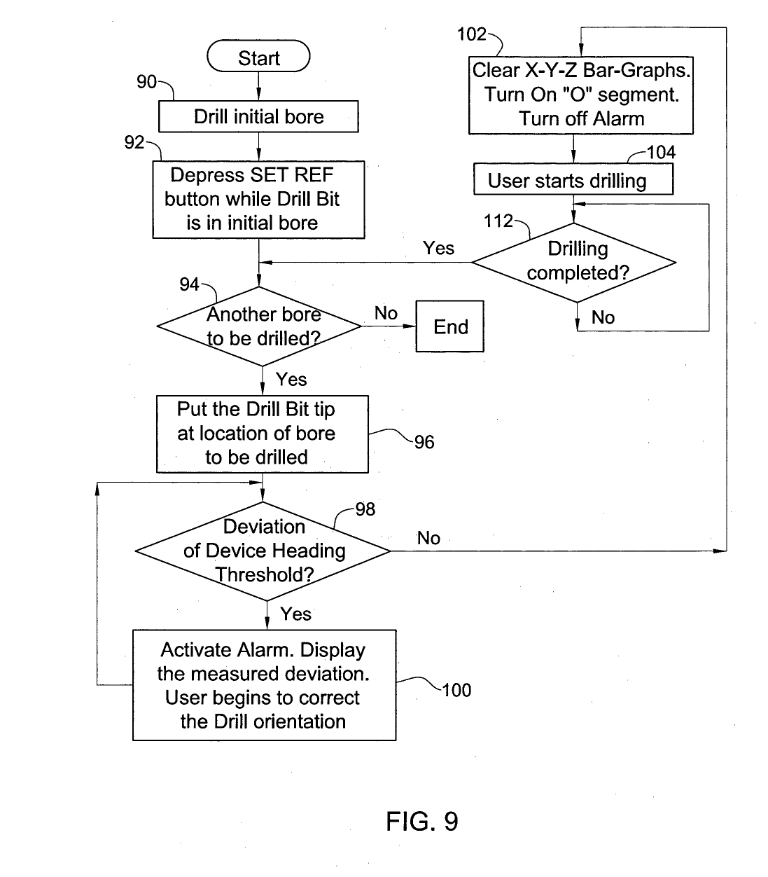

FIG. 9 shows a flow chart for a method of restorative dentistry using the device of the invention. The process begins with the drilling of an initial bore in a jaw (step 90). As shown in FIG. 3, this involves placing the tip of the drill bit 7 at the location on the alveolar ridge 5 where the initial bore is to be drilled. Upon termination of the drilling of the initial bore, the drill bit is kept in the initial bore and the set reference button 8 is depressed (step 92). This determines the reference orientation of the device 1, as explained above. In step 94, it is then determined whether an additional bore is to be drilled. If no, then the process terminates. Otherwise, the drill bit is positioned at the location of the next bore to be drilled (step 96), and it is then determined whether the current deviation of the device orientation is above a predetermined threshold (step 98). FIG. 4 shows preparation for drilling the next bore. If the drill is placed at the point where the next bore is to be drilled but with some deviation 40 from the reference orientation (the lines 41 and 42, indicating the orientation of the drill bit 7 in the initial bore and the present bore, respectively, are not parallel) that exceeds the predetermined threshold, the alarm as well as X-Y-(Z) bar-graphs are activated to urge the user to manipulate drill to bring the device into the reference orientation. As shown in FIG. 5, when the drill at the new location is in the reference orientation, the orientation of the drill bit 7 (indicated by the line 42) is parallel to the orientation of the drill bit when the previous bore was drilled (indicated by the line 41). The drill is manipulated by the user while referring to the graphical display so as to reduce the deviation (step 100), (as shown in FIG. 5), and the process returns to step 98 with another comparison of the current and reference device orientations.

If in step 98 it is determined that the deviation of the current and reference device orientations is not above the predetermined threshold, then the process continues with step 102 where the X- Y-(and Z, if present) bar graphs are cleared and then in step 104, the drilling of the new bore begins. During drilling, whenever the device is in or near the reference orientation (FIG. 5), the X-Y-(Z) bar-graphs are cleared and the O-point is turned on to indicate that deviation between the current and reference orientations is below the predetermined deviation. It is then determined whether the drilling of the present bore has been completed (step 112). If yes, then the drilling is stopped and the process returns to step 94 where it is determined whether another bore is to be drilled. Otherwise the drilling continues and the process returns to step 112.

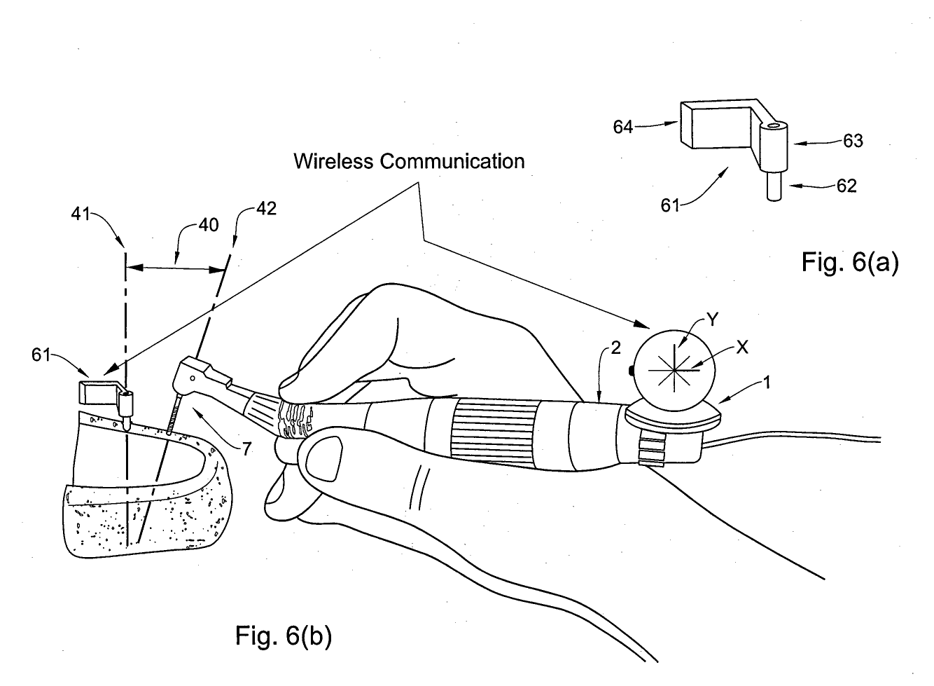

In another embodiment of the invention in, after drilling an initial bore, a pilot 61, shown FIGS. 6a and 6b, with a bushing 63 for top or bottom attachment of a pin 62 is inserted into the initial bore. The pilot 61 includes a unit 64 with orientation sensors, battery and a microcontroller, integrated with a wireless transceiver. The pilot 61 is inserted into the initial bore and continuously monitors the orientation of the initial bore and wirelessly transmits to the device 1 the orientation of the initial bore, which may change during the procedure due to movement of the patient. The device 1 updates the reference orientation received from the pilot 61 which is inserted into the initial bore and continuously compares the current orientation of the initial bore with the current device orientation. The deviation between the two orientations is indicated on the graphical display, as explained above. When the deviation is above a predetermined threshold, the alarm is activated. This allows for compensation of the device for the patient's movement.

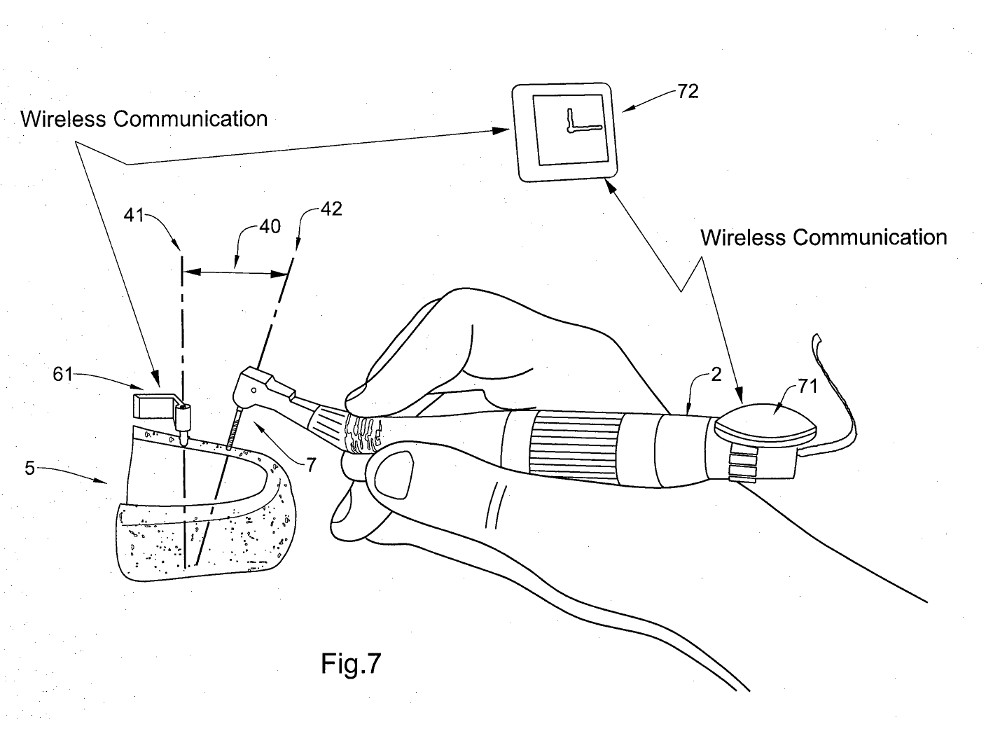

In another embodiment of the invention in the FIG. 7, a graphical display 72 is used that is not integral with the base part 71. Communication between the pilot 61, the base part 71 and the display 72, may be via a wired communication channel or a wireless communication channel.

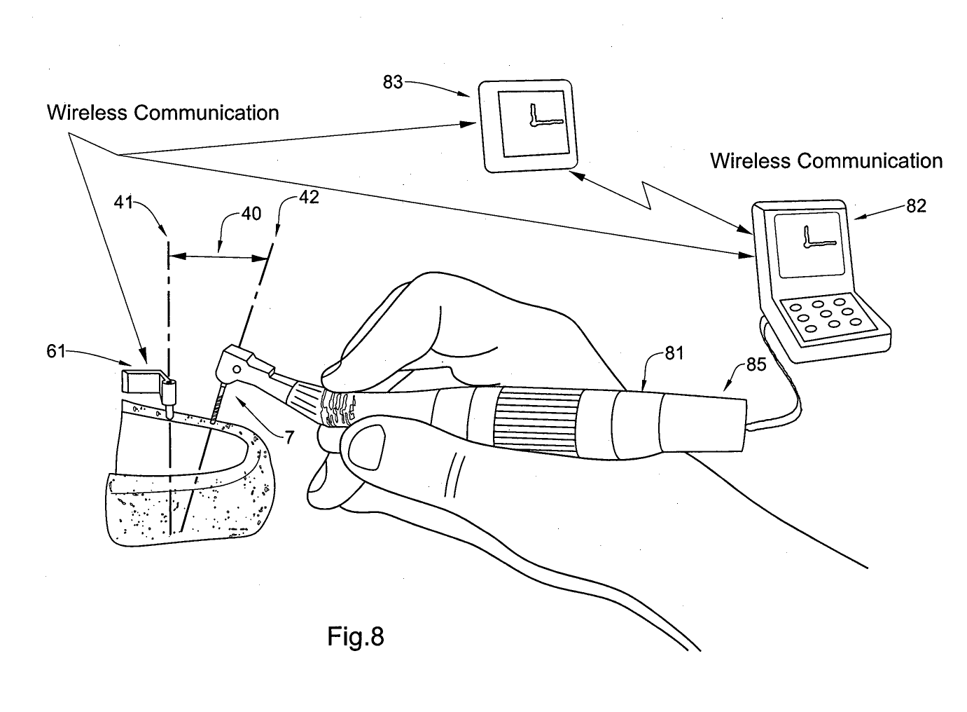

FIG. 8 shows another embodiment of the invention comprising a hand-held dental drill 81 having integral orientation sensors 85. This embodiment also includes a pilot 61. A processor that determines the drill orientation from the orientation sensors 85 and a pilot 61 may be integral with a motor control unit 82 that controls the rotation and torque of the drill 81. The orientation may be indicated graphically on a graphical display that may also be integral with the motor control unit 82, or may be housed in a separate unit 83. Communication between the sensors 85, the pilot 61 and the processor may be via a wired communication channel or a wireless communication channel.

1.-15. (canceled)

16. A system for monitoring the orientation of a hand-held surgical or dental tool comprising:
(a) a device comprising one or more orientation sensors generating one or more signals indicative of an orientation of the device;
(b) a pilot, adapted to be rigidly affixed to a body and comprising one or more orientation sensors generating signals indicative of an orientation of the pilot; and
(c) a processor configured to
(i) receive the signals from the orientation sensor and the pilot;
(ii) periodically or continuously calculate from the received signals a current orientation of the device; the current orientation being specified by a current unit vector defined by a first current angle formed between the current unit vector and a predetermined first fixed axis and a second current angle formed by the current unit vector and a second predetermined axis;
(iii) compare a current orientation of the device with the current orientation of the pilot; the pilot orientation being specified by a reference unit vector defined by a first angle formed between the reference unit vector and the predetermined first fixed axis and a second angle formed by the reference unit vector and the second predetermined axis; and
(iv) provide an indication of a deviation between a current orientation of the device and the pilot orientation.

17. The system according to claim 16, wherein the one or more orientation sensors comprise a 3-axis rate gyroscope.

18. The system according to claim 16, wherein the one or more orientation sensors comprise a 3-axis accelerometer and a 3-axis geomagnetic sensor.

19. The system according to claim 16, wherein the one or more orientation sensors comprise a gyroscope installed on freely rotating frames.

20. The system according to claim 16, further comprising means for affixing the device to the hand-held tool.

21. The system according to claim 16, further comprising a graphical display for displaying an indication of a deviation between a current orientation of the device and the reference orientation.

22. The system according to claim 21, wherein the graphical display displays an indication of Euler angles of the deviation between the reference orientation and a current orientation.

23. The system according to claim 21, wherein the graphic display displays two Euler angles.

24. The system according to claim 21, wherein the graphic display displays three Euler angles.

25. The system according to claim 16, further comprising an alarm generating a sensible signal when the alarm is activated, and wherein the processor is further configured to activate the alarm when the deviation between the reference orientation and a current orientation exceeds a predetermined threshold.

26. The system according to claim 16, wherein the processor is further configured to receive data indicative of the reference orientation and to store the reference orientation in the memory.

27. The system according to claim 25, further provided with a set reference button, the set reference button causing the processor to determine an orientation of the device when the set reference button is depressed and to store the determined orientation in the memory as the reference orientation.

28. A surgical or dental tool, comprising a system for monitoring the orientation of a hand-held surgical or dental tool, the system comprising:
(a) a device comprising one or more orientation sensors generating one or more signals indicative of an orientation of the device;
(b) a pilot, adapted to be rigidly affixed to a body and comprising one or more orientation sensors generating signals indicative of an orientation of the pilot; and
(c) a processor configured to
(i) receive the signals from the orientation sensor and the pilot;
(ii) periodically or continuously calculate from the received signals a current orientation of the device; the current orientation being specified by a current unit vector defined by a first current angle formed between the current unit vector and a predetermined first fixed axis and a second current angle formed by the current unit vector and a second predetermined axis;
(iii) compare a current orientation of the device with the orientation of the pilot; the pilot orientation being specified by a reference unit vector defined by a first angle formed between the reference unit vector and the predetermined first fixed axis and a second angle formed by the reference unit vector and the second predetermined axis; and
(iv) provide an indication of a deviation between a current orientation of the device and the pilot orientation.
